(19) United States
(12) Patent Application Publication
(10) Pub. No.: US 2012/0298471 A1
(43) Pub. Date: Nov. 29, 2012

(54) SEALED BACKING PLATE DRIVE CONNECTION

(75) Inventor: Thomas Heck, Wooster, OH (US)

(73) Assignee: SCHAEFFLER TECHNOLOGIES AG & CO. KG, Herzogenaurach (DE)

(21) Appl. No.: 13/458,245

(22) Filed: Apr. 27, 2012

Related U.S. Application Data
(60) Provisional application No. 61/489,099, filed on May 23, 2011.

(51) Int. Cl. F16D 13/60

(52) U.S. Cl. 192/112

(57) ABSTRACT

A backing plate connection includes a hub having an outer surface comprised of flat surfaces and arcuate surfaces and a backing plate including an inner bore surface complementary to and press-fit onto the hub outer surface. The hub and the plate are sealingly connected and drivingly connected at the complementary surfaces. In some example embodiments, the hub includes a groove for receiving a snap ring. In an example embodiment, the groove is a plurality of groove segments extending circumferentially through the arcuate surfaces and ending at the flat surfaces. In an example embodiment, the hub is arranged to be fixed to a torque converter cover. In an example embodiment, the hub is integrally formed with a torque converter cover.

### FIELD

The invention relates generally to a backing plate connection, and more specifically to a sealed backing plate connection with a drive connection.

### BACKGROUND

Backing plates for torque converters are known. Some prior art designs include a welded connection between the backing plate and a hub. The welded connection prevents rotation of the backing plate relative to the hub, and seals the backing plate to the hub. Welding is an additional process and adds expense to the manufacture of the torque converter.

### BRIEF SUMMARY

Example aspects broadly comprise a backing plate connection including a hub having an outer surface comprised of flat surfaces and arcuate surfaces and a backing plate including an inner bore surface complementary to and press-fit onto the hub outer surface. The hub and the plate are sealingly connected and drivingly connected at the complementary surfaces. In some example embodiments, the hub includes a groove for receiving a snap ring. In an example embodiment, the groove is a plurality of groove segments extending circumferentially through the arcuate surfaces and ending at the flat surfaces. In an example embodiment, the hub is arranged to be fixed to a torque converter cover. In an example embodiment, the hub is integrally formed with a torque converter cover.

Other example aspects broadly comprise a hub for a torque converter including a plurality of arcuate segments forming respective first portions of a radially outwardly facing surface and having a same radius and a plurality of flat segments connecting the plurality of arcuate segments and forming respective second portions of the radially outwardly facing surface. The pluralities of arcuate and flat segments are arranged for sealing engagement with a backing plate for the torque converter. In some example embodiments, the arcuate segments form portions of a cylinder having a circular edge and the flat segments extend from chords of the circular edge along the length of the cylinder. In an example embodiment, the flat segments form portions of a cuboid.

In some example embodiment, a number of arcuate segments in the plurality of arcuate segments equals a number of flat segments in the plurality of flat segments. In an example embodiment, the number of arcuate segments and the number of flat segments is four. In some example embodiments, the hub includes a plurality of grooves, for receiving a snap ring, disposed in the arcuate segments. In an example embodiment, the plurality of grooves extends entirely through respective arcuate segments and intersect with respective flat segments.

Other example aspects broadly comprise a torque converter including a cover for driving engagement with a prime mover, a hub fixedly connected to the cover and including a backing plate mounting surface with arcuate segments and flat segments, and a backing plate drivingly and sealingly connected to the hub at a sealing portion having an aperture shaped complementary to the backing plate mounting surface. In some example embodiments, the backing plate has a press-fit connection with the backing plate mounting surface. In some example embodiments, the torque converter includes a snap ring for axially retaining the backing plate. The hub includes a groove and the snap ring is disposed in the groove. In some example embodiment, the torque converter includes a piston plate sealingly engaged with the hub and drivingly engaged with the backing plate or the cover. In an example embodiment, the hub includes a flow channel with an opening axially disposed between the backing plate and the piston plate.

### BRIEF DESCRIPTION OF THE DRAWINGS

The nature and mode of operation of the present invention will now be more fully described in the following detailed description taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a top-half section view of a torque converter with a sealed backing plate drive connection according to an example aspect;

FIG. 2A is a perspective detail view of a portion of a cover hub;

FIGS. 3A through 3C are schematic representations of a portion of the cover hub of FIG. 2 showing an example combination of basic shapes used to form a sealing surface.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

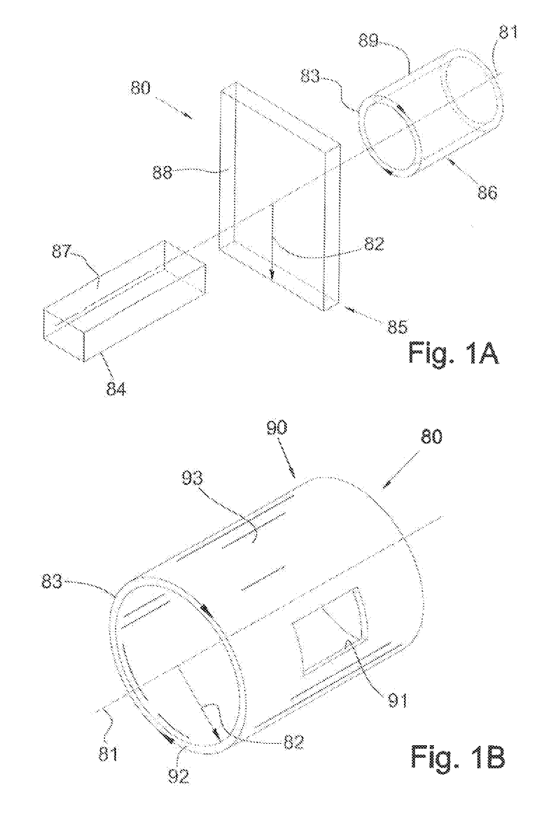

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential surface.

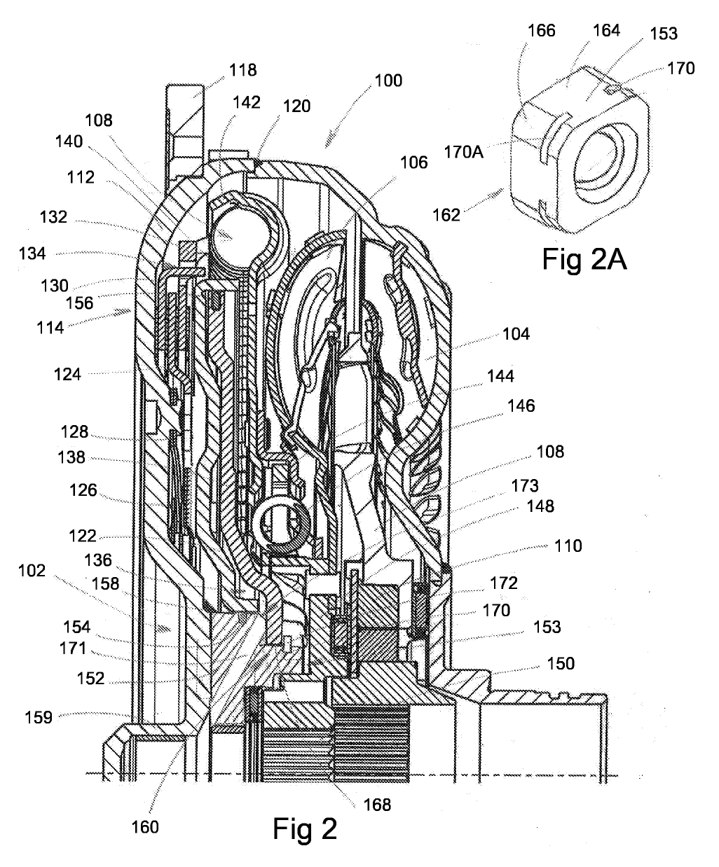

The following description is made with reference to FIG. 2. FIG. 2 is a top-half section view of torque converter 100 with sealed backing plate drive connection 102 according to an example aspect. Torque converter 100 is for installation between an engine or other prime mover (not shown) and a transmission (not shown) for a vehicle. Converter 100 includes impeller assembly 104, turbine assembly 106 and stator assembly 108 forming a fluid circuit. The fluid circuit allows slip between the engine and transmission when the vehicle is stopped, and, by preventing rotation of stator assembly 108 with one-way clutch 110, provides torque multiplication during vehicle launch.

Converter 100 also includes cover assembly 112, clutch assembly 114 and damper assembly 116 forming a mechanical circuit. Cover 112 includes lugs 118 for driving engagement with the vehicle engine, and is fixed to impeller 104 via weld 120. After launch, the fluid circuit is less efficient than the mechanical circuit, so clutch 114 is hydraulically engaged with cover 112 to lock the converter activate the mechanical circuit. During this “lockup” condition, torque is transmitted from cover 112 through clutch 114 and damper 116 to a transmission input shaft as will be described in more detail below.

Piston plate 122 and cover drive ring 124 are drivingly engaged with cover 112 via respective leaf spring sets 126 and 128. In some embodiments (not shown), piston plate 122 is drivingly engaged with backing plate 138 instead of cover 112. Damper drive ring 130 and damper drive plate 132 are engaged with one-another at tab connection 134. Pressure in chamber 136 between piston 122 and backing plate 138 urges the piston towards cover 112, clamping rings 124 and 130, and drive plate 132 to transmit torque from cover 112 to damper assembly 116. Torque received by spring 140 from plate 132 is transmitted to spring retainer 142 and cover plate 144, through spring 146 to flange hub 148, and out to the input shaft at spline 150.

Piston plate 122 is sealed with cover hub 152 at seal 154, and sealed with backing plate 138 at seal 156. Hub 152 is fixed to cover 112 by weld 158, for example. Although hub 152 is shown fixed to cover 112 by weld 158, the hub may be attached to the cover by other methods including projection welding, adhesives, or brazing, for example. In other embodiments (not shown), hub 152 may be integrally formed with cover 112 similar to pilot 159. Backing plate 138 is drivingly and sealingly engaged with portion 153 of cover hub 152 at backing plate connection 160.

The following description is made with reference to FIGS. 2 and 2A. FIG. 2A is a perspective detail view of portion 153 of cover hub 152. Backing plate connection 160 includes hub 152 and backing plate 138. As can best be seen in FIG. 2A, portion 153 of hub 152 includes outer surface, or backing plate mounting surface, 162 with flat surfaces (or segments) 164 and arcuate surfaces (or segments) 166. Backing plate 138 includes inner bore surface, or sealing portion, 168 complementary to hub outer surface 162. By complementary to, we mean that bore surface 168 includes flat surfaces and arcuate surfaces for engaging the flat and arcuate surfaces, respectively, of hub outer surface 162.

Surface 168 is press-fit onto surface 162. Otherwise stated, backing plate 138 is forcefully engaged with portion 153 of hub 152. Plate 138 and hub 152 are sealingly connected and drivingly connected at the complementary surfaces 162 and 168. Backing plate 138 is drivingly and sealingly connected to hub 152 at sealing portion 168. Portion 168 has an aperture shaped complementary to backing plate mounting surface 162.

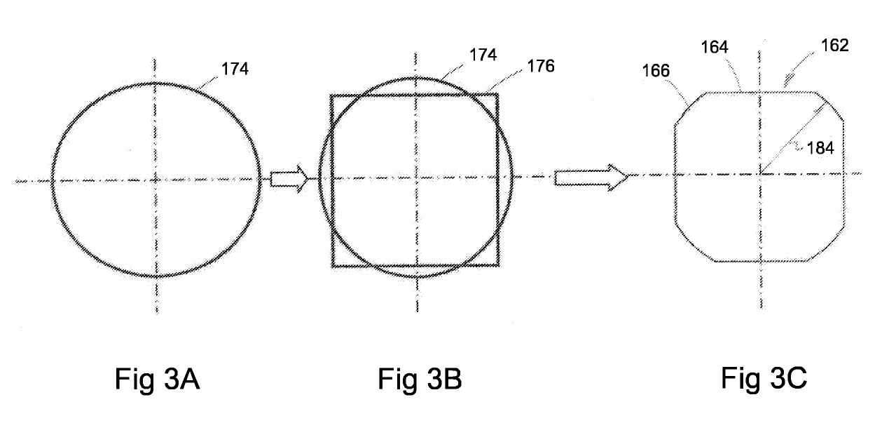

FIGS. 3A through 3C are schematic representations of portion 153 of cover hub 152 of FIG. 2 showing an example combination of basic shapes used to form sealing surface 162. The following description is made with reference to FIGS. 2-3C. Portion 153 of hub 152 may include groove 170 for receiving snap ring 172. As shown in FIG. 2A, groove 170 may be a plurality of groove segments (i.e., segments 170A and 170B) extending circumferentially through arcuate surfaces 166 and ending at flat surfaces 164. Otherwise stated, hub 152 includes grooves 170, for receiving snap ring 172, disposed in arcuate segments 166. That is, snap ring 172 is disposed in grooves 170. Grooves 170 extend entirely through respective arcuate segments 166 and intersect with respective flat segments 164. Hub 152 includes flow channel 171 with opening 173 axially disposed between backing plate 138 and piston plate 122.

As can be seen in FIGS. 3A through 3C, portion 153 of hub 152 may be shown schematically as a combination of circle 174 and square 176. Intersected profile 178 includes arcuate segments 166. Segments 166 form portions of radially outwardly facing surface 162. Arcuate segments 166 have a common or same radius 184. Although segments 166 are shown as portions of circle 174, segments 166 may be portions of another shape such as an oval or a parabola, for example. Similarly, radius 184 may be variable for individual segments 166. In other embodiments (not shown), segments 166 may be combinations of arcuate shapes.

Flat segments 164 connect arcuate segments 166, forming portions of radially outwardly facing surface 162. Otherwise stated, arcuate segments 166 form portions of a cylinder having circular edge 174 and flat segments 164 extend from chords of circular edge 174 along the length of the cylinder (i.e., into or out of the page when viewed as shown in FIG. 3). As portions of square 176, flat segments 164 form portions of a cuboid. Although shown as portions of square 176, segments 164 may be portions of another shape including a triangle, hexagon, or any other polygon. Similarly, surface 162 may contain more or fewer segments 164. For example, surface 162 may contain a single flat segment 164, or, where segments 166 are combinations of arcuate shapes as described above, surface 162 may not contain any flat segments 164. That is, the combined arcuate segments enable driving engagement of portion 153 of hub 152 and plate 138.

In the embodiment shown in FIG. 3, surface 186 has an equivalent number of arcuate segments 180 and flat segments 186. Surface 186 includes four arcuate segments 180 and four flat segments 186, although other numbers of segments 180 and 186 are possible. Arcuate segments 180 and flat segments 186 are arranged for sealing engagement with backing plate 138 as described above.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What We claim is:

1. A backing plate connection comprising:
a hub having an outer surface comprised of flat surfaces and arcuate surfaces; and,
a backing plate including an inner bore surface complementary to and press-fit onto the hub outer surface so that the hub and the plate are sealingly connected and drivingly connected at the complementary surfaces.

2. The connection of claim 1, wherein the hub comprises a groove for receiving a snap ring.

3. The connection of claim 2, wherein the groove is a plurality of groove segments extending circumferentially through the arcuate surfaces and ending at the flat surfaces.

4. The connection of claim 1, wherein the hub is arranged to be fixed to a torque converter cover.

5. The connection of claim 1, wherein the hub is integrally formed with a torque converter cover.

6. A hub for a torque converter comprising:
a plurality of arcuate segments forming respective first portions of a radially outwardly facing surface and having a same radius; and,
a plurality of flat segments connecting the plurality of arcuate segments and forming respective second portions of the radially outwardly facing surface, wherein the pluralities of arcuate and flat segments are arranged for sealing engagement with a backing plate for the torque converter.

7. The hub of claim 6 wherein the arcuate segments form portions of a cylinder having a circular edge and the flat segments extend from chords of the circular edge along the length of the cylinder.

8. The hub of claim 7 wherein the flat segments form portions of a cuboid.

9. The hub of claim 6 wherein a number of arcuate segments in the plurality of arcuate segments equals a number of flat segments in the plurality of flat segments.

10. The hub of claim 8 wherein the number of arcuate segments and the number of flat segments is four.

11. The hub of claim 6 further comprising a plurality of grooves, for receiving a snap ring, disposed in the arcuate segments.

12. The hub of claim 11 wherein the plurality of grooves extends entirely through respective arcuate segments and intersect with respective flat segments.

13. A torque converter comprising:
a cover for driving engagement with a prime mover;
a hub fixedly connected to the cover and including a backing plate mounting surface with arcuate segments and flat segments; and,
a backing plate drivingly and sealingly connected to the hub at a sealing portion having an aperture shaped complementary to the backing plate mounting surface.

14. The torque converter of claim 13 wherein the backing plate has a press-fit connection with the backing plate mounting surface.

15. The torque converter of claim 14 further comprising a snap ring for axially retaining the backing plate, wherein the hub includes a groove and the snap ring is disposed in the groove.

16. The torque converter of claim 15 further comprising a piston plate sealingly engaged with the hub and drivingly engaged with the backing plate or the cover.

17. The torque converter of claim 16 wherein the hub includes a flow channel with an opening axially disposed between the backing plate and the piston plate.
